(19) United States
(12) Patent Application Publication
(10) Pub. No.: US 2007/0180445 A1
(43) Pub. Date: Aug. 2, 2007

(54) Download Service For Device Drivers

(75) Inventor: Esaias E. Greeff, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,806

(22) Filed: Jan. 30, 2006

(51) Int. Cl. G06F 9/445

(52) U.S. Cl. 717/174; 717/178

(57) ABSTRACT

Systems and methods for providing a download service for device drivers include a client and a driver download service. The client requests from the driver download service a location from which a driver for a device may be fetched. The driver download service responds with the location from which the device driver may be fetched. The client then requests the device driver from each of the locations.

### BACKGROUND

Modern computing systems often use peripheral devices, whether such devices are connected directly to the computing system, or are made accessible to the computing system over a local or wide area network. Typically, such peripheral devices include associated device drivers, which are software packages that enable the computing system to fully utilize the peripheral devices.

Manufacturers of the peripheral devices generally supply the device drivers on, for example, a compact disk (CD), floppy, or other machine-readable medium, and include such media in the package with the peripheral device. When installing a new peripheral device onto a computing system, the user typically loads the media into the computing system, so that an operating system or other utility can read the device drivers from the media and install the device drivers.

While workable in some circumstances, the foregoing approach suffers some disadvantages. The user is burdened with having to load the drivers when installing a new peripheral device, or when moving the peripheral device from one machine to another. However, the media containing the drivers are often lost or damaged over time, thereby making the drivers inaccessible. Additionally, the manufacturers of the peripheral devices typically load the media when the device is manufactured. However, the device drivers may be updated frequently during the expected lifetime of the peripheral devices, thereby rendering the originally-supplied device drivers obsolete.

One approach to addressing the foregoing issues is for the manufacturer to provide updated device drivers on, for example, websites accessible over the Internet. While workable for experienced or savvy users, the process of finding, accessing, and loading device drivers from manufacturer websites can still be daunting and error-prone for many users. For example, each manufacturer may organize its website differently, and each website may present different interfaces for finding, downloading, and installing the device drivers. Users having to locate and install a variety of device drivers from different manufacturers may become frustrated and confused. Also, this approach is only feasible if the user has Internet connectivity: if the user has lost the original media containing the device driver, and also does not have Internet connectivity, the user may have reached an impasse.

In another approach, suppliers of operating systems or other system-level utilities may offer an update service. Such an update service may automatically search for and locate a suitable device driver from a pre-existing store of device drivers. In broad outline, such services operate by receiving a unique identifier indicating the type of device for which a driver is sought, and by searching the store of device drivers for an entry matching the input unique identifier. The store of device drivers may be maintained locally by the operating system, or may be accessible over the Internet. In either case, however, the location of the device drivers is known ahead of time; the only question is whether that location contains a suitable driver.

### SUMMARY

Systems, methods, and/or techniques (“tools”) for providing a download service for device drivers include a client and a driver download service. The client requests from the driver download service a location from which a driver for a device may be fetched. The driver download service responds with the location from which the device driver may be fetched.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTIONS OF THE DRAWINGS

Tools for providing a download service for device drivers are described in connection with the following drawing figures. The same numbers are used throughout the disclosure and figures to reference like components and features. The first digit in a reference number indicates the drawing figure in which that reference number is introduced.

FIG. 1 is a block diagram of an operating environment for providing a download service for device drivers.

FIG. 2 is a block diagram of illustrative metadata that is related to a given device for which the download service may provide a device driver.

FIG. 3 is a block diagram of illustrative contents of a request to obtain a location for the device driver.

FIG. 4 is a block diagram of illustrative contents of a response to the request shown in FIGS. 1 and 3.

FIG. 5 is a flow diagram of a process for requesting a location of a device driver.

FIG. 6 is a flow diagram of a process for responding to the request for a location of device driver information.

### DETAILED DESCRIPTION

Overview

The following document describes tools capable of many techniques and processes. The following discussion describes exemplary ways in which the tools provide a download service for device drivers. This discussion also describes other techniques performed by the tools.

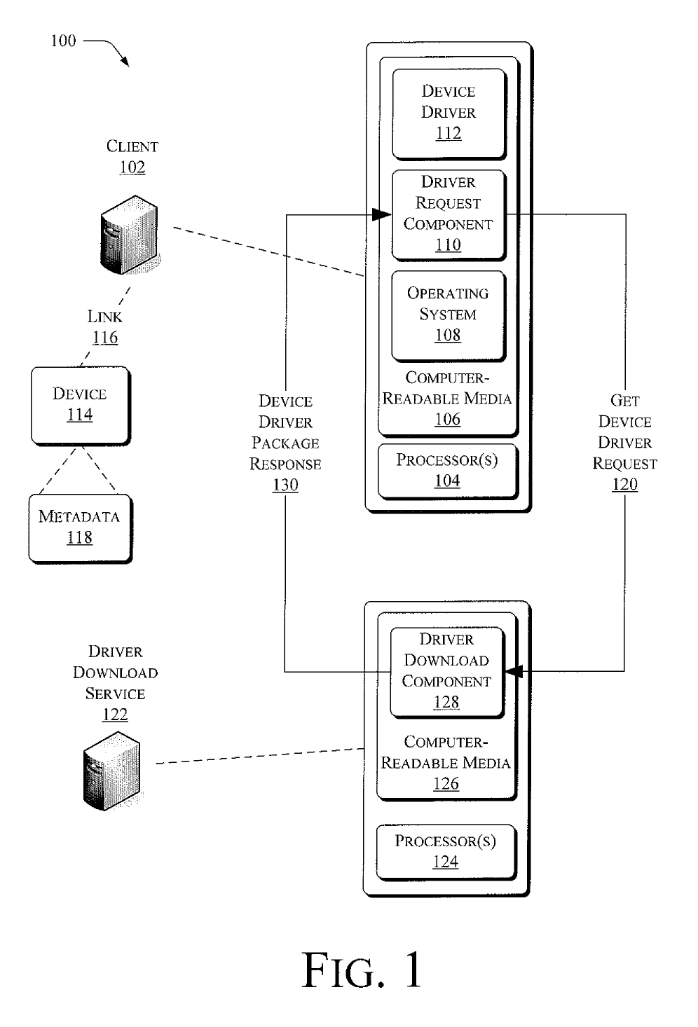

For convenience only, but not limitation, this document is organized into sections, with the sections introduced by corresponding headings. First, Operating Environments are described in connection with FIG. 1. FIG. 1 illustrates operating environments related to providing a download service for device drivers, and also provides illustrative data flows.

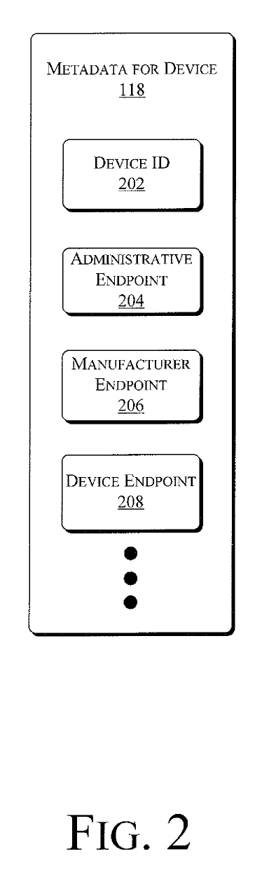

Next, Data Structures and Schemas are described in connection with FIGS. 2-4. FIGS. 2-4 illustrate examples of device metadata, requests for device driver locations, and responses to such requests.

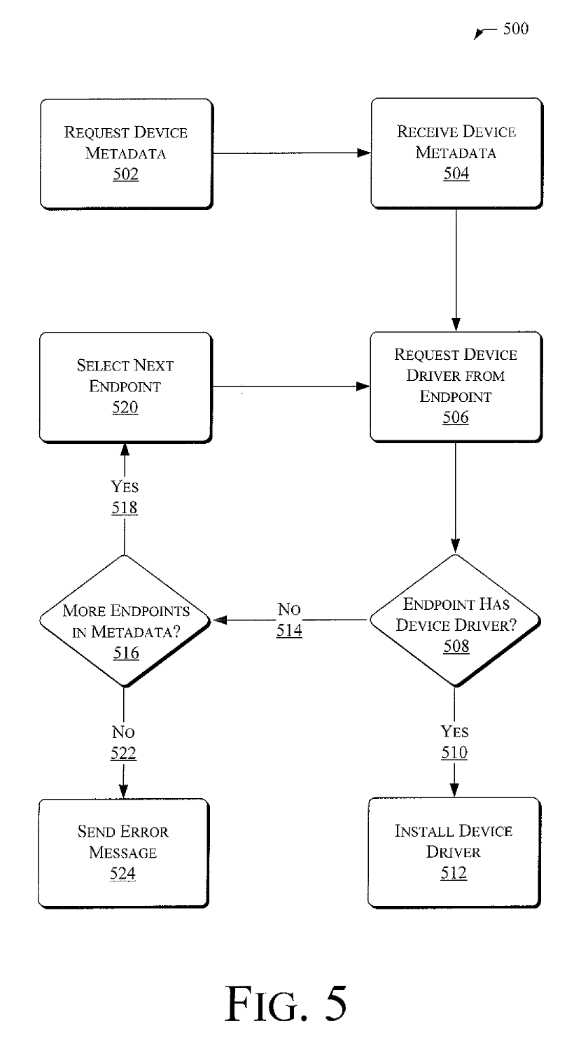

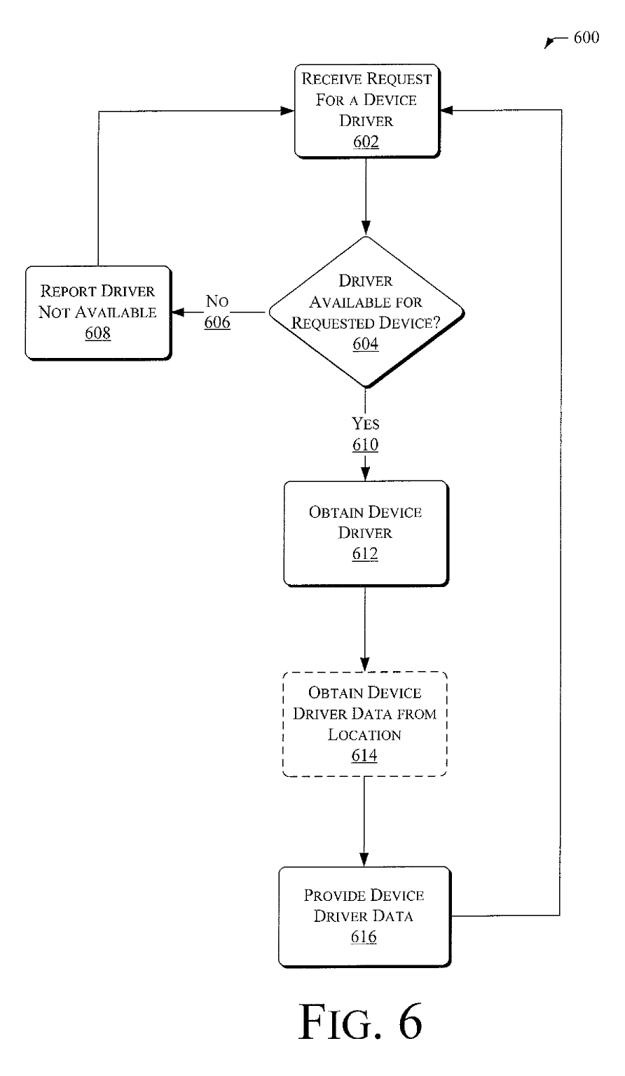

Finally, Process Flows and Protocols are described in connection with FIGS. 5-6. FIGS. 5-6 illustrate example process flows and protocols for requesting locations from which device drivers may be fetched, and for responding to such requests.

Operating Environments

FIG. 1 illustrates an operating environment 100 suitable for providing a download service for device drivers. The operating environment 100 may include one or more clients 102. FIG. 1 shows one representative client 102 only for convenience of illustration, but not to limit possible implementations of the operating environment 100. In general, the operating environment 100 may include any number of clients 102. The client 102 may include a computing device, such as a network or other server, a desktop computer, a laptop or notebook computer, a mobile telephone, a personal digital assistant (PDA), a handheld computer, or the like.

The client 102 may include one or more processor(s) 104 and computer-readable media 106. The computer-readable media 106 may contain instructions that, when executed by the processor 104, perform any of the tools described herein. The processor 104 may be configured to access and/or execute the instructions embedded or encoded onto the computer-readable media 106. The processor 104 may also be categorized or characterized as having a given architecture.

The computer-readable media 106 may also include an operating system 108, which may take the form of any commercially available operating system. Suitable but non-limiting examples of the operating system 108 can include any of the WINDOWS® family of operating systems available from Microsoft Corporation of Redmond, Wash. Other examples of the operating system 108 can include any of the LINUX® operating systems, or any operating system available from Apple Computer, Inc. of Cupertino, Calif.

The computer-readable media 106 may also include a driver request component 110. The driver request component 110 may be implemented as a module, program, or other entity capable of interacting directly or indirectly with one or more entities external to the client 102. Illustrative functions and capabilities of the driver request component 110 are detailed below in connection with describing the tools. In overview, the driver request component 110 enables the client 102 to request and obtain one or more device drivers 112 corresponding to one or more devices 114.

The client 102 may be connected to one or more devices 114 by corresponding links 116. FIG. 1 shows one representative device 114 only for convenience of illustration, but not to limit possible implementations of the operating environment 100. The device 114 may be coupled directly to the client 102. In such cases, the link 116 may include, for example, a USB cable and related ports.

In other cases, the device 114 may be coupled to the client 102 by a network. This network is not shown in FIG. 1 for clarity of illustration, but can take any suitable form, and is represented generally by the link 116. For example, the network may be a local area network (LAN), a wide area network (WAN) such as the Internet, or any combination thereof. In such cases, the client 102 can access the device 114 over this network. Conversely, the device 114 may be shared among a plurality of clients 102 over the network.

The device 114 can be any device that is external or peripheral to the client 102. Illustrative but non-limiting examples of the device 114 can include printers, multi-function peripherals (MFPs), scanners, cameras, microphones, or the like.

Instances of the device 114 are associated with corresponding device drivers 112. When the device 114 is either connected to the client 102, or is made available to the client over a network, the client 102 may obtain a suitable device driver 112 using the tools described herein. For example, the operating system 108 may detect the device 114, and may further determine that it does not have a device driver 112 for the device 114. Alternatively, the operating system 108 may have a device driver 112 for the device 114, but may determine that the device driver 112 is outdated.

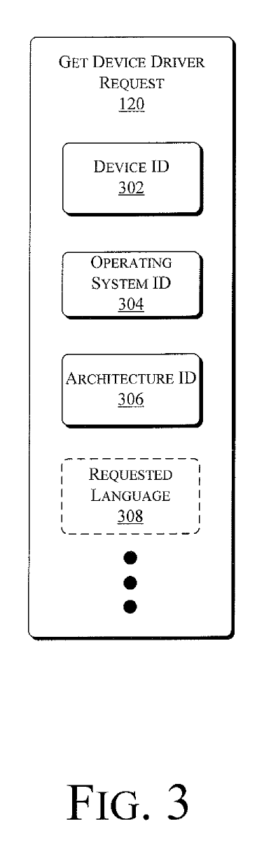

To support the operation of the tools as described herein, the device 114 may include metadata 118 that specifies where the client 102 may obtain new or updated files for the device driver 112. Examples of such metadata 118 are illustrated and described in FIG. 3 below.

In any event, whether to obtain or to update the device driver 112, a component on the client 102 may submit a request to obtain a location for a suitable device driver 112. As part of this request, the client 102 may request and receive the metadata 118 from the device 102. The metadata 118 specifies locations or endpoints from which the client 102 may request the device driver 112. Given this information, the client 102 may then direct suitable requests for the device driver 112 to the one or more endpoints specified in the metadata 118. FIG. 1 shows an example of such a request as a device driver request 120. For example, the driver request component 110 may submit the get device driver request 120.

The get device driver request 120 may be submitted to a driver download service 122. An instance of the driver download service 122 is provided at each endpoint specified by the metadata 118. In but one possible implementation, the driver download service 122 may be hosted by the device 114. In other possible implementations, the driver download service 122 may be hosted by a centralized entity servicing a plurality of clients 102, such as a server deployed in an enterprise environment. The driver download service 122 may also be hosted by manufacturer of the devices 114, and be accessible over a wide area network, such as the Internet.

In any event, the entity hosting the driver download service 122 may comprise a computing device, which in turn can include a processor 124 and computer readable media 126. The computer readable media 126 can include a driver download component 128 that receives and services the get device driver request 120, using the tools described herein. The driver download component 128 provides a device driver package response 130 to the get device driver request 120. For example, the driver request component 110 may receive and process the device driver package response 130. In turn, the device driver 112 may be installed on the client 102 by, for example, the operating system 108 or the driver request component 110.

It is understood that the description herein uses the terms “get device driver request”, “driver request component”, “device driver package response”, and “driver download component” only for convenience, but not for limitation. It is further understood that implementations of the operating environment 100 may provide similar functionality, but under different names.

Data Structures and Schemas

Having described the operating environment 100 in FIG. 1, the discussion turns to a description of various data structures and schemas that may be employed by the various components of the operating environment 100. This description begins with discussing the metadata 118 in more detail. Examples of the metadata 118 are now described in connection with FIG. 2.

FIG. 2 illustrates the metadata 118 related to a given device 114 for which the driver download component 128 may provide a device driver 112. At least some of the various devices 114 that may be available to the clients 102 store instances of corresponding metadata 118. For a given device 114, the metadata 118 can include a device ID field 202 that identifies the device 114 to which the metadata 118 pertains.

Fields 204, 206, and 208 of the metadata 118 correspond to various locations or endpoints from which the device drivers 112 may be obtained. At least one of the fields 204, 206, and 208 is populated for a given instance of the metadata 118.

In but one possible implementation, the device drivers 112 may be centralized in a given location by administrators or other persons managing one or more of the clients 102. In such implementations, the field 204 may contain a reference to an administrative endpoint corresponding to a driver download component 128 where the device driver 112 may be located. The administrative endpoint may be accessible via, for example, a corporate or other intranet, or over the Internet. The particular administrative endpoint reference may be defined for a given enterprise by the responsible administrators.

In another possible implementation, the device driver 112 may be available from, for example, a website provided by a manufacturer of the device 114. In such implementations, the field 206 may contain a reference to a manufacturer endpoint, such as a website or web service hosted by a manufacturer or other independent hardware vendor (IHV). The device driver 112 may be available from a driver download component 128 that is hosted at the manufacturer endpoint, which may be accessible, for example, over the Internet.

In another possible implementation, the device driver 112 may be available from a driver download component 128 hosted on the device 114 itself. In such implementations, the field 308 contains a reference to a device endpoint where the device driver 112 may be obtained from the driver download component 128 hosted on the device 114. In instances where the client 102 does not have network connectivity, the client 102 may be directed to obtain the device driver 112 from the device 114.

In illustrating and describing the above fields 202-208 of the metadata 118, it is understood that implementations of the metadata 118, or equivalent structures, could include fields besides those shown in FIG. 2. The open-ended nature of the illustration shown in FIG. 2 is conveyed by the ellipsis shown in FIG. 2.

It is noted that, for example, the device 114 may provide the metadata 118 upon request from, for example, the driver request component 110, or more generally, the client 102. This request may be labeled as a “Get Device Metadata” request, or the like. The client 102 and/or driver request component 110 may use the metadata 118 to populate at least part of one or more get device driver request 120 shown in FIG. 1.

For the endpoints (e.g., 204, 206, and/or 208) that are populated in the metadata 118 for a given device 114, the driver request component 110 may populate and send a respective get device driver request 120 to these endpoints, until a device driver 112 is successfully obtained. For example, the driver request component 110 may populate a field in the request 120 with the device ID field 202 from the metadata 118.

At the given endpoints, the driver download component 126 may refer to the device ID field 202 in the request 118 to determine for which device 114 to find a driver 112. The driver download component 126 can then, in turn, search for a device driver 112 for this device 114. For example, a plurality of the device drivers 112 may be collected into a data store for reference by the driver download component 128. The data store can be searched to locate a device driver 112 that matches a device ID field in the input get device driver request 120.

Metadata 118 for a given device 114 may be populated initially by a manufacturer of the device 114. The metadata 118 may be stored, for example, in the firmware of the device 114. In some instances, the metadata 118 as stored by the manufacturer of the device 114 may be replaced or overridden by, for example, system administrators managing a plurality of the clients 102.

This description uses the following syntax to define normative outlines for messages. The syntax appears as an XML instance, and values in italics indicate data types instead of values. Characters are appended to elements and attributes to indicate cardinality, as follows:
“?” (0 or 1)
“*” (0 or more)
“+” (1 or more)
The character “|” is used to indicate a choice between alternatives.
The characters “[” and “]” are used to indicate that contained items are to be treated as a group with respect to cardinality or choice.

Ellipses (i.e., “ . . . ”) indicate a point of extensibility that allows other child or attribute content. Additional children and/or attributes MAY be added at the indicated extension points.

An example XML-based implementation of the metadata 118 is presented below:

```
<dds:DriverDownloadLocations>
  <dds:DeviceIdentifier>xs:anyURI</dds:DeviceIdentifier>
  [<dds:AdminastrativeEPR>
    endpoint-reference
  </dds:AdminastrativeEPR>] ?
  [<dds:ManufacturerEPR>
    endpoint-reference
    </dds:ManufacturerEPR>]
  [<dds:DeviceEPR>
    endpoint-reference
  </dds:DeviceEPR>] ?
  ...
</dds:DriverDownloadLocations >
```

Having described examples of the metadata 118 available for various devices 114, the description turns to the get device driver request 120, shown in more detail in FIG. 3.

FIG. 3 illustrates example contents of the get device driver request 120, as shown in FIG. 1. For example, the get device driver request 120 may be implemented as a message that passes from the client 102 to the driver download service 122 provided at each of the endpoints specified in the metadata 118. The get device driver request 120 can include a device identifier (ID) field 302, which is used to identify the device 114 for which a driver 112 is sought, and to obtain the correct device driver 112 for the device 114.

An operating system ID field 304 identifies the operating system 108 on the client 102. It is understood that different device drivers 112 may be provided for different operating systems 108 that may be running on different clients 102.

An architecture ID field 306 identifies the architecture of the processor 104 on the client 102. It is understood that different device drivers 112 may be provided for different architectures and different operating systems 108 that may be running on the clients 102. Non-limiting examples of such architectures can include x86, x64, Itanium, or the like.

In some instances, the device driver 112 may be localized for a particular language. In such instances, the get device driver request 118 may populate a requested language field 308. The requested language field 308 can indicate which language the device driver 112 should support. For example, the device driver 112 may provide prompts, labels, or other text in dialog boxes in human-readable language. Thus, the requested language field 308 may indicate English, Spanish, French, German, or any other human-readable language.

As suggested above, some instances of the device drivers 112 are not localized. Accordingly, the requested language field 308 may be viewed as an optional field that is not populated when the get device driver request 118 is requesting a non-localized device driver 112. The optional nature of the requested language field 308 is conveyed by the dashed outline of block 308 in FIG. 3. Additionally, it is noted that, in characterizing the requested language field 308 as optional, the description herein is not to be interpreted as stating that other elements shown herein are essential or mandatory in all implementations.

In illustrating and describing the above fields 302-306 of the get device driver request 120, it is understood that implementations of the get device driver request 120, or equivalent requests, could include fields besides those shown in FIG. 3. The open-ended nature of the illustration shown in FIG. 3 is conveyed by the ellipsis shown in FIG. 3.

An example XML-based implementation of the get device driver request 120 is presented below:

```
<dds:GetDeviceDriver>
  <dds:DeviceIdentifier>xs:anyURI</dds:DeviceIdentifier>
  <dds:OSIdentifier>xs:anyURI</dds:OSIdentifier>
  <dds:RequestedArchitecture>xs:string</dds:RequestedArchitecture>
  <dds:RequestedLanguage>xs:string</dds:RequestedLanguage>
  ...
</dds:GetDeviceDriver>
```

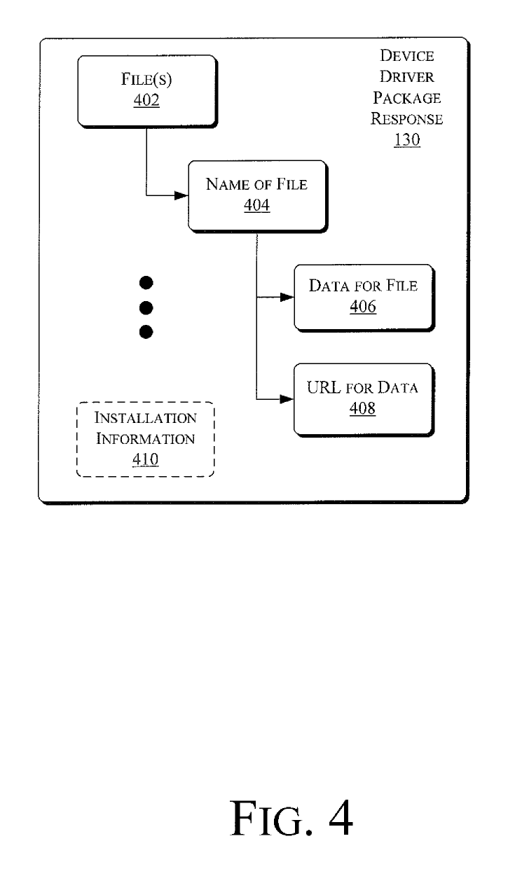

Having described the get device driver request 120 in connection with FIG. 3, the discussion turns to the device driver package response 130, shown in more detail in FIG. 4.

FIG. 4 illustrates example contents of the device driver package response 130, which can be provided as a response to the get device driver request 120. As shown in FIG. 4, the device driver package response 130 can include one or more files 402 that make up the device driver 112. FIG. 4 shows one representative file 402 for convenience of illustration only, but not to limit possible implementations. In general, a device driver 112 may contain any number of files 402.

For the respective device driver files 402, the device driver package response 130 may contain a field 404 providing relative path names for the files 402. For each file 402 and corresponding path name 404, the device driver package response 128 may populate one of the fields 406 or 408. The field 406 may contain the data for the device drivers 112, encoded, for example, in a Base64 representation. In implementations, the field 406 may be encoded using a Message Transmission Optimization Mechanism (MTOM) or similar methods. The field 408 may contain a URL from which the device driver file may be fetched using, for example, an HTTP GET command. The device driver package response 130 may also populate an installation information field 410. The installation information field 410 may contain any information provided by, for example, a given operating system supplier to facilitate loading or installing the device driver 112 for execution under the given operating system. Thus, the contents of the installation information field 410 may be specific to particular operating systems, and may not be populated in all instances of the device driver package response 128. Thus, the optional nature of the installation information field 410 is conveyed in FIG. 4 by the dashed outline of the block 410.

An example XML-based implementation of the response 130 is presented below:

```
<dds:DeviceDriverPackage>
  <dds:Files>
    [<dds:File Name=xs:string>
      [
          <dds:FileURL>xs:anyURI</dds:FileURL>
        |
          <dds:FileData>xs:base64Binary</dds:FileData>
      ]
    </dds:File>] +
  </dds:Files>
  [<dds:InstalationInfo>
    ...
  </dds:InstalationInfo>] ?
...
</dds:DeviceDriverPackage>
```

In illustrating and describing the above fields 402-410 of the device driver package response 130, it is understood that implementations of the device driver package response 130, or equivalent structures, could include fields besides those shown in FIG. 4. The open-ended nature of the illustration shown in FIG. 4 is conveyed by the ellipsis shown in FIG. 4.

Process Flows and Protocols

Having described the data structures and related schemas in connection with FIGS. 2-4, the discussion now turns to a description of various process flows and related protocols that may be performed in connection with providing a download service for device drivers. These process flows are described in connection with FIGS. 5 and 6. For convenience only, FIGS. 5 and 6 are described in connection with certain components of the operating environment 100. However, it is noted that the process flows shown in FIGS. 5 and 6 could be implemented in connection with other components without departing from the scope and spirit of the description herein.

FIG. 5 illustrates a process flow 500 for requesting a location of device driver information. For convenience and ease of discussion, the process flow 500 is described here in connection with the client 102 shown in FIG. 1. However, it is understood that the process flow 500 may be implemented on devices or components other than the client 102 or the other components shown in the operating environment 100 without departing from the spirit and scope of the description herein.

Turning to the process flow 500 in more detail, block 502 requests device metadata for a given device. In but one possible implementation, FIG. 1 provides an example an example device 114, and FIG. 2 illustrates example metadata 118. Recall that the device 114 may store its metadata 118, and provide this metadata 118 upon request.

Block 504 receives device metadata 118 in response to the request shown in block 502. Recall that the device metadata may specify at least one endpoint from which the device driver may be obtained.

Block 506 requests a device driver (e.g., device driver 112) from the first endpoint specified in the device metadata 118. Block 508 evaluates whether the endpoint from which the device driver was requested in block 506 can provide the device driver. For example, block 508 may examine a response received from the endpoint to determine a status of the request made in block 506.

From block 508, if the current endpoint has provided the requested device driver, the process flow 500 takes Yes branch 510 to block 512, where the device driver is installed in, for example, the computer readable media 106.

Returning to block 508, if the current endpoint does not contain or cannot provide the requested device driver, the process flow 500 takes No branch 514 to block 516. Block 516 determines whether the metadata received in block 504 provides any more endpoints from which the device driver files may be fetched.

From block 516, if the metadata specifies more endpoints from which the device driver may be requested, then the process flow 500 takes Yes branch 518 to block 520. In block 520, the next endpoint specified in the device metadata is selected as the current endpoint. The process flow 500 then returns to block 506 to request the device driver from this new current endpoint. The process flow 500 then repeats evaluation block 508, as discussed above.

From block 516, if the metadata specifies no more endpoints from which the device driver may be requested, then the process flow 500 takes No branch 522 to block 524. If the process flow 500 reaches block 524, then it cannot provide a device driver for the device. Block 524 reports an appropriate error message.

Having provided the above description of the process flow 500, it is noted that the metadata provided by the device (e.g., the device 102) may specify the order in which the endpoints are to be queried for the device driver. Additionally, the metadata can specify which endpoints are to be queried.

Having described a process flow 500 for requesting a new or updated device driver, a process for responding to such a request is now described in connection with FIG. 6.

FIG. 6 illustrates a process flow 600 for responding to a request for a device driver. For convenience and ease of discussion, the process flow 600 is described here in connection with the driver download service 120 shown in FIG. 1. In some implementations, an instance of the driver download service 122 may be provided at the endpoints specified in the device metadata. The driver download service 122 may respond to requests for the device driver, provided by, for example, the process flow 500 shown in FIG. 5. However, it is understood that the process flow 600 may be implemented on devices or components other than the driver download service 122 or the other components shown in the operating environment 100 without departing from the spirit and scope of the description herein. More generally, it is understood that the process flow 600 may be performed by any endpoint specified in device metadata to service a request for a device driver. Non-limiting examples of device metadata 118 and related endpoints 204, 206, and 208 are illustrated in FIG. 2.

Turning to the process flow 600 in more detail, block 602 receives a request for a driver for a given device. As noted above, FIG. 1 provides an example device 114, an example device driver 112, and an example get device driver request 120.

Block 604 determines whether the requested device driver is available at the given endpoint. If the given endpoint cannot provide the requested device driver, the process flow 600 takes No branch 606 to block 608. Block 608 reports that the given endpoint cannot provide the requested device driver. The response provided in block 608 may be input to the decision block 508 shown in FIG. 5, which evaluates whether a given endpoint can provide a device driver.

After block 608, the process flow 600 returns to block 602 to await the next request for a device driver directed to that given endpoint.

Returning to block 604, if the requested device driver is available, then the process flow 600 takes Yes branch 610 to block 612. Block 612 obtains either the requested device driver, or a location from which the device driver files may be fetched.

In some implementations of the process flow 600, block 614 may fetch and load the actual device driver files from the location specified in block 612. The actual device driver files may then be loaded into the body of the response to the request received in block 602. In other instances, the response to the request may include a pointer or reference that provides the location from which the device driver files may be fetched. Thus, block 614 may be viewed as optional in nature, as conveyed by the dashed outline of the block 614 in FIG. 6.

Block 616 provides a response to the request received in block 602. FIG. 1 provides an example device driver package response 128, sent from the driver download service 120 to the client 102. Different instances of the response may include the device driver files themselves, or a pointer or reference providing a location from which the device driver files may be fetched.

### CONCLUSION

Although the system and method has been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

In addition, regarding certain flow diagrams described and illustrated herein, it is noted that the processes and sub-processes depicted therein may be performed in orders other than those illustrated without departing from the spirit and scope of the description herein.

1. A system comprising:
at least one client that includes a driver request component adapted for sending a first request to a device for at least one endpoint from which to fetch a driver for the device, and for sending at least a second request for the device driver to the endpoint; and
at least one driver download service for receiving the second request, and for providing a response to the second request.

2. The system of claim 1, wherein the driver request component is adapted to include in the second request at least one of a device identifier (ID) indicating the device for which the location of the driver is requested, an operating system ID indicating an operating system for which the driver is requested, and an architecture ID indicating a processor architecture type for which the driver is requested.

3. The system of claim 1, wherein the driver request component is adapted to include in the second request a requested language parameter indicating a human-readable language to be supported by the driver.

4. The system of claim 1, wherein the driver request component is adapted to extract from the response at least one file containing the device driver, and to install the device driver on the client.

5. The system of claim 1, wherein the driver request component is adapted to extract from the response a location containing the device driver, to access at least one file containing the device driver from the location, and to install the device driver on the client.

6. The system of claim 1, further comprising the device, and wherein the device includes metadata specifying the at least one endpoint from which the device driver may be requested, and wherein the device is adapted to provide the metadata to the client in response to the first request.

7. The system of claim 1, wherein the driver download service includes a driver download component adapted to receive the second request, and to provide the response to the second request.

8. The system of claim 1, wherein the client service is adapted to refer to metadata obtained from the device, wherein the metadata specifies at least one endpoint from which the device driver may be requested.

9. The system of claim 1, wherein the client is adapted to refer to metadata obtained from the device, wherein the metadata specifies at least one of the following endpoints from which the driver may be requested:
a device endpoint;
an administrative endpoint associated with the client; and
a manufacturer endpoint associated with a manufacturer of the device.

10. The system of claim 1, wherein the driver download service is adapted to send a response including at least one file for the device driver.

11. The system of claim 1, wherein the driver download service is adapted to send a response including at least one location from which the device driver may be fetched.

12. The system of claim 1, wherein the driver download service is adapted to send a response including installation information related to the device driver.

13. A method executable at least in part by a computer-based system, the method comprising:
requesting metadata from a device specifying at least one endpoint from which a driver for the device may be requested; and
requesting the device driver from at least the endpoint specified in the metadata.

14. The method of claim 13, further comprising specifying at least one of an operating system, a processor architecture, and a device identifier for the driver.

15. The method of claim 13, further comprising specifying a requested language for the driver.

16. A schema implementing, at least in part, the method of claim 13.

17. A method executable at least in part by a computer-based system, the method comprising:
receiving a request for a driver for a device; and
sending a response to the request.

18. The method of claim 17, wherein the method is performed by at least one endpoint specified in metadata provided by the device, wherein the metadata specifies at least one of the following locations from which the driver may be requested:
the device;
an administrative endpoint associated with the client; and
a manufacturer endpoint associated with a manufacturer of the device.

19. A schema implementing, at least in part, the method of claim 17.

20. The method of claim 17, wherein sending a response includes sending a response that contains one of:
a message indicating that the device driver is not available;
at least one file for the device driver; or
a location from which at least one file for the device driver may be fetched.
